(19) United States
(12) Patent Application Publication
(10) Pub. No.: US 2014/0267337 A1
(43) Pub. Date: Sep. 18, 2014

(54) Pre-Defined Streaming Media Buffer Points

(71) Applicant: International Business Machines Corporation, Armonk, NY (US)

(72) Inventors: Susann M. Keohane, Austin, TX (US); Gerald F. McBreartry, Austin, TX (US); Shawn P. Mullen, Buda, TX (US); Jessica C. Murillo, Round Rock, TX (US); Johnny M. Shieh, Austin, TX (US)

(73) Assignee: International Business Machines Corporation, Armonk, NY (US)

(21) Appl. No.: 14/027,233

(22) Filed: Sep. 15, 2013

Related U.S. Application Data
(63) Continuation of application No. 13/795,182, filed on Mar. 12, 2013.

(51) Int. Cl. G06T 1/60

(52) U.S. Cl. CPC G06T 1/60
USPC 345/545

(57) ABSTRACT

An approach is provided in which a source entity generates scene fill metadata corresponding to scene transition points included in media content. The scene fill metadata includes a “required buffer amount,” which indicates an amount of the media content for which a destination entity should buffer prior to displaying one or more upcoming scenes. In turn, the source entity provides the scene fill metadata to a destination entity.

### BACKGROUND

The present disclosure relates to buffering streaming media content at a content receiver during scene transitions within the media content.

Media content streaming is typically a process by which a content distributor provides media content (e.g., a movie) to a content receiver over some type of network connection, such as a satellite channel, a cable channel, or the Internet. A content distributor may be an entity that distributes media content, such as a television station, a streaming Internet channel, a video streaming service, etc. A content receiver may be a system, device, or module that receives the media content at a user's location and displays the media content on a display.

### BRIEF SUMMARY

According to one embodiment of the present disclosure, an approach is provided in which a source entity generates scene fill metadata corresponding to scene transition points included in media content. The scene fill metadata includes a “required buffer amount,” which indicates an amount of the media content for which a destination entity should buffer prior to displaying one or more upcoming scenes. In turn, the source entity provides the scene fill metadata to a destination entity.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a diagram showing a source entity generating scene fill metadata and providing the scene fill metadata to a destination entity;

FIG. 2A is a diagram showing a content producer generating scene fill metadata and providing the scene fill metadata and the media content to a content distributor;

FIG. 2B is a diagram showing a content producer providing composite media content to a content distributor, which includes scene fill metadata and media content;

FIG. 3A depicts an embodiment of scene fill metadata embedded at the beginning of composite media content;

FIG. 3B depicts an embodiment of scene fill metadata provided to a destination entity over a channel separate from the media content channel;

FIG. 4A depicts an embodiment of a dark screen being displayed during an extended scene transition at which time a content receiver increases its actual buffer amount to meet a subsequent scene's required buffer amount;

FIG. 4B depicts an embodiment of a commercial being displayed during an extended scene transition while a content receiver increases its actual buffer amount to meet a subsequent scene's required buffer amount;

FIG. 5 is a diagram showing a user interface that allows a user to customize the required buffer amount;

FIGS. 6A, 6B, and 6C depict embodiments of scene fill metadata whose required buffer amounts are represented by various requirement values;

FIG. 7 is a flowchart showing steps taken in a source entity generating scene fill metadata;

FIG. 8 is a flowchart showing steps taken in a content receiver buffering scenes included in media content based upon corresponding scene fill metadata;

FIG. 9 is a block diagram of a data processing system in which the methods described herein can be implemented; and

FIG. 10 provides an extension of the information handling system environment shown in FIG. 9 to illustrate that the methods described herein can be performed on a wide variety of information handling systems which operate in a networked environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The following detailed description will generally follow the summary of the disclosure, as set forth above, further explaining and expanding the definitions of the various aspects and embodiments of the disclosure as necessary.

FIG. 1 is a diagram showing a source entity (e.g., content distributor) generating scene fill metadata and providing the scene fill metadata to a destination entity (e.g., content receiver). At times, the network connection that streams the media content to the content receiver slows down due to heavy traffic. As such, the content receiver ceases to display the media content at random locations in order to buffer the media content. This disclosure discusses embodiments to methodically buffer the media content between scene transitions in order to present a more enjoyable viewing experience for the user.

In one embodiment, the scene transitions, or “scene transition points” may correspond to media transitions used in a post-production process of film editing and/or video editing by which scenes or shots are combined. Some media content may also include selective use of other transitions, such as to convey a tone or mood, suggest the passage of time, or separate parts of a storyline.

In this disclosure, the source entity that identifies the scene transition points may utilize a library of industry-standard “routines” to recognize various industry-standard scene transitions. As those skilled in the art can appreciate, industry-standard scene transitions may include L-cuts, fades, match cuts, wipes, etc. In one embodiment, the media content's audio signal (sound track) may be utilized to define scenes and scene transitions. For example, background music typically changes from scene to scene, thus framing the scene. In another example, dialog between actors may define the start and end of a scene. In one embodiment, a content producer (e.g., film production company) may supply one or more of the “routines” specific to their content to a content distributor in order for the content distributor to adequately identify the scene transition points.

Content distributor 100, shown in FIG. 1, includes scene fill metadata generator 110. Scene fill metadata generator 110 analyzes media content 120 and detects that scene A 124 resides between scene transition points 122 and 126. As such, scene fill metadata generator 110 identifies the size (e.g., number of frames) of scene A 124 (or a substantial portion of scene A 124) and determines a “required buffer amount” that the content receiver (150) is required to have buffered prior to displaying scene A 124. The required buffer amount may be represented in a number of frames, a time duration, a data size, etc. (see FIGS. 6A-6C and corresponding text for further details).

Scene fill metadata generator 110 identifies a scene transition frame identifier based upon a scene transition frame corresponding to scene transition point 122 (e.g., frame #1243), and, in one embodiment, stores the scene transition frame identifier and the required buffer amount in temporary store 115. Scene fill metadata 110 proceeds to analyze media content 120 to locate scenes requiring upfront buffering at the content receiver (e.g., long scenes and/or graphics intensive scenes) and generate/store the corresponding scene fill metadata in temporary store 115.

Once scene fill metadata generator 110 is finished analyzing media content 120, scene fill metadata 110 creates composite media content 140, which includes the scene fill metadata and media content 120. FIG. 1 shows an embodiment where scene fill metadata 110 embeds scene fill metadata 142 (corresponding to scene A 124) and scene fill metadata 144 (corresponding to scene B 128) in line with media content 120. In other embodiments, scene fill metadata 110 may include the scene fill metadata at the beginning of media content 120 (see FIG. 3A) or on a separate channel (see FIG. 3B) that is sent to the content receiver.

Content distributor 100 sends composite media content 140 over streaming channel 145 (e.g., Internet, satellite, etc.) to content receiver 150. Content receiver 150 includes media content decode/display module 160, which decodes composite media content 140 and buffers the media content in media content buffer 170. When media content decode/display module 160 detects scene fill metadata, media content decode/display module 160 compares the actual buffer amount included in the media content buffer 170 with the required buffer amount included specified in the scene fill metadata. When the actual buffer amount does not meet the required buffer amount, media content decode/display module 160 extends a scene transition (between scenes) until the actual buffer amount meets the required buffer amount. In one embodiment, media content decode/display module 160 displays a dark screen. In another embodiment, media content decode/display module 160 displays a commercial (see FIG. 5 and corresponding text for further details).

Media content decode/display module 160 provides buffered media content 180 to display 190. Buffered media content 180 includes scenes A 124 and B 128, and also includes extended scene transitions 182 and 184 (e.g., dark screen or commercial). As a result, by extending the scene transitions between scenes in order to buffer the media content to the required buffer amount, a user is able to view the subsequent scenes in their entirety without interruption.

FIG. 1 shows that the “source entity” that generates the scene fill metadata is a content distributor and the “destination entity” that receives the scene fill metadata is a content receiver. In another embodiment, the source entity that generates the scene fill metadata may be a content “producer,” such as a movie production company. In this embodiment, the destination entity that receives the scene fill metadata may be a content distributor that, in turn, provides the media content and scene fill metadata to a content receiver (see FIGS. 2A-2B and corresponding text for further details).

FIG. 2A is a diagram showing a content producer generating scene fill metadata and providing the scene fill metadata and the media content to a content distributor. Content producer 200 is a source entity that creates media content 120 and also generates scene fill metadata 210 (e.g., scene fill metadata 142, 144 shown in FIG. 1). Content distributor 100 is the destination entity that receives scene fill metadata 210 and media content 120.

In one embodiment, content distributor 100 receives media content 120 and scene fill metadata 210 over a computer network. In another embodiment, content distributor 100 receives media content 120 and scene fill metadata 210 via a physical storage device, such as a DVD. In yet another embodiment, content distributor 100 receives media content 120 via a physical storage device and receives scene fill metadata 210 over a computer network.

Content distributor 100 creates composite media content 140 from media content 120 and scene fill metadata 210, and distributes composite media content 140 to content receiver 150 as discussed in FIG. 1.

FIG. 2B is a diagram showing a content producer providing composite media content to a content distributor, which includes scene fill metadata and media content. FIG. 2B is similar to FIG. 2A with the exception that content producer 200 “combines” media content 120 and scene fill metadata 210 to create composite media content 140. As such, content distributor 100 is alleviated from the combining steps and distributes composite media content 140 to content receiver 150.

FIG. 3A depicts an embodiment of scene fill metadata embedded at the beginning of composite media content. A source entity (content producer or content distributor) may prefer to include scene fill metadata at the beginning of composite media content 140 to avoid “breaking up” media content 120 (e.g., inserting the scene fill metadata at scene transition points such as that shown in FIG. 1). Since the scene fill metadata (scene fill metadata 142 and 144) includes scene transition frame identifiers, the content receiver is able to receive the upfront scene fill metadata and buffer the media content accordingly as the scene transition frames arrive.

FIG. 3B depicts an embodiment of scene fill metadata provided to a destination entity over a channel separate from the media content channel. Similar to the embodiment shown in FIG. 3A, a source entity may wish to provide the scene fill metadata separately from the media content to avoid breaking up media content 120. FIG. 3B shows channel A 300 and channel B 310. In one embodiment, these channels may be separate streaming media channels.

In another embodiment, one channel may be an Internet-based channel and the other channel may be a satellite-based channel. In either embodiment, the channels are not required to be synchronized with one another because the scene fill metadata includes scene transition frame identifiers. In these embodiments, the scene fill metadata should arrive at the content receiver prior to its corresponding scene. For example, since scene fill metadata 142 includes information pertaining to scene A 124, scene fill metadata 142 should arrive at the content receiver prior to scene A 124 arriving at the content receiver in order to allot enough time to buffer scene A 124 if required.

FIG. 4A depicts an embodiment of a dark screen being displayed during an extended scene transition at which time a content receiver increases its actual buffer amount to meet a subsequent scene's required buffer amount. FIG. 4A shows display 190 displaying scene A (e.g., an outdoor scene). At the end of scene A, a content receiver displays a dark screen on display 190 for an extended time period that allows the content receiver to buffer scene B. Once the content receiver buffers the required buffer amount, the content receiver displays scene B on display 190 without interruption.

FIG. 4B depicts an embodiment of a commercial being displayed during an extended scene transition while a content receiver increases its actual buffer amount to meet a subsequent scene's required buffer amount. In one embodiment, a user may wish to view a commercial while the content receiver is buffering the media content and, in turn, receive discounted moving pricing. In this embodiment, the commercial may be downloaded and stored in memory prior to the content receiver downloading the media content in order to display the commercial real-time when needed. In one embodiment, when the user finishes viewing a commercial, the user's content receiver may transmit a message to the content distributor, which credits the user's account accordingly (see FIG. 5 and corresponding text for further details)

FIG. 5 is a diagram showing a user interface that allows a user to customize the required buffer amount. In one embodiment, a content receiver may prompt a user with user interface window 500, which allows a user to customize extended scene transition viewing experiences.

Window 500 includes selection boxes 510 and 530, which allows a user to increase or decrease the required buffer amount based upon the scene fill metadata. In one embodiment, a user may select box 510 and enter a percentage number in box 520 to increase or decrease the required buffer amount by a certain percentage (e.g., when streaming bandwidth is unusually light or heavy). In this embodiment, the user may enter “120,” in which case the content receiver would increase the required buffer amount included in the scene fill metadata by 20% (e.g., 2,000 frames*1.20). In another embodiment, the user may select box 530 and enter a number in text box 540 to increase or decrease the required buffer amount included in the scene fill metadata by an amount of time (e.g., +1 second, −1 second, etc.).

Window 500 also includes selection boxes 550 and 560, which allows a user to select either a dark screen or a commercial during times at which the content receiver is buffering a subsequent scene. In one embodiment, when a user does not select either box 550 or 560, the content receiver may display a dark screen during short buffer times (e.g., less than 5 seconds) and display a commercial during longer buffer times (e.g., greater than 5 seconds).

FIGS. 6A, 6B, and 6C depict embodiments of scene fill metadata whose required buffer amounts are represented by various requirement values. FIG. 6A shows scene fill metadata 142 including fields 600 and 610. Field 600 includes a scene transition frame identifier that indicates a frame number (scene transition frame) corresponding to a scene transition point. For example, the scene transition frame may be a dark scene located between two different scenes, or the scene transition frame may be located in the middle of a fade from one scene to the next scene. Field 610 includes a required buffer amount represented by an amount of frames. As discussed below, the required buffer amount may also be represented in a time duration or a data size.

FIG. 6B depicts an embodiment of scene fill metadata 142 whose required buffer amount includes a time duration (field 620). FIG. 6C depicts an embodiment of scene fill metadata whose required buffer amount includes a data size (field 630). As those skilled in the art can appreciate, other representation of scene fill metadata may be utilized in scene fill metadata 142 other than that shown in FIG. 6A, 6B, or 6C.

FIG. 7 is a flowchart showing steps taken in a source entity generating scene fill metadata. FIG. 7 will be discussed below in the context of a content distributor being the source entity that generates the scene fill metadata. As discussed herein, the source entity may also be a content producer that generates the scene fill metadata utilizing steps similar to those shown in FIG. 7.

Processing commences at 700, whereupon processing analyzes media content 120 and locates scene transition points (step 710). In one embodiment, the scene transition points may correspond to film transitions used in post-production process of film editing and video editing by which scenes or shots are combined. At step 720, processing identifies scene transition points whose subsequent scenes require buffering. For example, a short scene (e.g., 5 seconds) between to scene transition points may not require buffering, but a longer, more involved scene may require buffering based upon typical streaming media data rates.

Processing selects the first identified scene transition point at step 730, and determines an amount of buffering that is required at step 740. For example, the scene may include 2,000 frames and processing determines that 2,000 frames worth of media content require buffering prior to displaying the scene.

Processing generates scene fill metadata at step 750, which, in one embodiment, includes the required buffer amount and a scene transition frame identifier that identifies a frame at or near the scene transition point. The scene fill metadata is stored in temporary store 115 (step 760), and a determination is made as to whether there are more scene transition points whose subsequent scenes require buffering (decision 770). If there are more scene transition points whose subsequent scenes require buffering, decision 770 branches to the “Yes” branch, which loops back to select and analyze the next scene transition point. This looping continues until there are no more scene transition points to process, at which point decision 770 branches to the “No” branch,

At step 780, processing provides the scene fill metadata and the media content to, for example, a content receiver, as composite media content 140. As discussed earlier, composite media content 140 may be provided in different forms, such as those shown in FIG. 1, 3A, or 3B. Processing ends at 790.

FIG. 8 is a flowchart showing steps taken in a content receiver buffering scenes included in media content based upon corresponding scene fill metadata. FIG. 8 shows an embodiment where a content receiver includes a content decode module and a content display module. The content decode module is responsible for decoding streaming media content and buffering the media content based upon the scene fill metadata, whereas the content display module is responsible for retrieving the decoded frames from the buffer and displaying the frames on a display. As those skilled in the art can appreciate, the content receiver may performs the steps shown in FIG. 8 using a different approach and/or with a single decode/display module.

Decode module processing commences at 800, whereupon the decode module retrieves user preferences 165 at step 805. The user preferences may indicate and increase or decrease in content buffering, as well as indicate a user's preference on what to display while the media content is in process of being buffered (see FIG. 5 and corresponding text for further details). At step 810, the decode module initiates media streaming, such as sending a “receive ready” signal to a content distributor.

At step 815, the decode module decodes the streaming media content (e.g., composite media content 140) and adds decoded media content frames to media content buffer 170. A determination is made as to whether scene fill metadata is detected (decision 820). The embodiment shown in FIG. 8 is based upon the scene fill metadata embedded in the streaming media content or provided on a separate channel (see FIGS. 1 and 3B). In an embodiment where the scene fill metadata is provided at the beginning of a media content, such as that shown in FIG. 3A, the decode module may store the “upfront” scene fill metadata and wait until a scene transition frame indicated in the scene fill metadata occurs.

Display module processing commences at 860, whereupon the display module retrieves buffered media content from media content buffer 170 and displays the media content on display 190. During the display process, the display module monitors the status of the scene transition extension flag (decision 870). When the scene transition extension flag is clear, the display module continues to retrieve media content (decision 870 “No” branch) from media content buffer 170 and display the retrieved media content on display 190.

Referring back to the decode module, when the decode module detects scene fill metadata, decision 820 branches to the “Yes” branch, whereupon the decode module compares the required buffer amount (included in the scene fill metadata) with the actual buffered amount of media content stored in media content buffer 170 (step 825). A determination is made as to whether more buffering is required (decision 830). In one embodiment, this decision is based upon whether the required buffer amount is larger than the actual buffered amount at a point in time.

In another embodiment, the decode module may account for the amount of additional buffering that will be added as a subsequent scene is displayed based upon current streaming data transfer rates. For example, assuming that the required buffer amount for a ten second scene indicates 2,000 frames, but only 1,000 frames of media content are currently buffered, processing determines that 1,000 frames more of media content are required to be buffered before displaying the subsequent scene. However, in this example, the decode module may also determine that the streaming data transfer rate is 500 frames per second and, since it would take 2 seconds to buffer the extra 1,000 frames and there are 5 seconds worth of media content already buffered, the decode module may not need to buffer additional media content.

If the decode module does not need to buffer more media content, decision 830 branches to the “No” branch, which loops back to continue to decode and buffer the media content. On the other hand, when the decode module needs to buffer more media content, decision 830 branches to the “Yes” branch, whereupon the decode module sets a scene transition extension flag at step 835. The scene transition extension flag indicates that the media content should be “paused” at the scene transition point (scene transition frame) in order for the decode module to buffer enough media content as to not risk interruption of the display module displaying the subsequent scene. The decode module, at step 840, decodes the media content and stores frames in media content buffer 170 until the actual buffer amount is equal to or greater to the required buffer amount. Once the decode module buffers a sufficient amount of media content, the decode module resets the scene transition extension flag at step 845.

Referring to the display module, when the decode module sets the scene transition extension flag, decision 870 branches to the “Yes” branch, whereupon the display module, in one embodiment, displays a scene transition frame (e.g., a dark screen) until the scene transition extension flag is reset (step 875). In another embodiment, based upon user preferences and/or the amount of time required to adequately buffer the subsequent scene, the display module may retrieve and display a particular commercial. In this embodiment, the content receiver may send a message to the content distributor that indicates the commercial was displayed that, in turn, initiates the content distributor to credit the user's account (e.g., provide a discount on a movie).

At the decode module, a determination is made as to whether there is more media content to process (decision 850). If there is more media content to process, decision 850 branches to the “Yes” branch, which loops back to process more media content and scene fill metadata. This looping continues until the streaming media content terminates, at which point decision 850 branches to the “No” branch, whereupon decode module processing ends at 855.

At the display module, when the scene transition extension frame resets, the display module determines whether to continue displaying the media content (decision 880). If the display module should continue to display the media content, decision 880 branches to the “Yes” branch, which loops back to retrieve media content (e.g., the subsequent scene that was buffered) from media content buffer 170 and display the media content on display 190. This looping continues until the media content terminates, at which point decision 880 branches to the “No” branch whereupon display module processing ends at 890.

FIG. 9 illustrates information handling system 900, which is a simplified example of a computer system capable of performing the computing operations described herein. Information handling system 900 includes one or more processors 910 coupled to processor interface bus 912. Processor interface bus 912 connects processors 910 to Northbridge 915, which is also known as the Memory Controller Hub (MCH). Northbridge 915 connects to system memory 920 and provides a means for processor(s) 910 to access the system memory. Graphics controller 925 also connects to Northbridge 915. In one embodiment, PCI Express bus 918 connects Northbridge 915 to graphics controller 925. Graphics controller 925 connects to display device 930, such as a computer monitor.

Northbridge 915 and Southbridge 935 connect to each other using bus 919. In one embodiment, the bus is a Direct Media Interface (DMI) bus that transfers data at high speeds in each direction between Northbridge 915 and Southbridge 935. In another embodiment, a Peripheral Component Interconnect (PCI) bus connects the Northbridge and the Southbridge. Southbridge 935, also known as the I/O Controller Hub (ICH) is a chip that generally implements capabilities that operate at slower speeds than the capabilities provided by the Northbridge. Southbridge 935 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 996 and “legacy” I/O devices (using a “super I/O” chip). The “legacy” I/O devices (998) can include, for example, serial and parallel ports, keyboard, mouse, and/or a floppy disk controller. The LPC bus also connects Southbridge 935 to Trusted Platform Module (TPM) 995. Other components often included in Southbridge 935 include a Direct Memory Access (DMA) controller, a Programmable Interrupt Controller (PIC), and a storage device controller, which connects Southbridge 935 to nonvolatile storage device 985, such as a hard disk drive, using bus 984.

ExpressCard 955 is a slot that connects hot-pluggable devices to the information handling system. ExpressCard 955 supports both PCI Express and USB connectivity as it connects to Southbridge 935 using both the Universal Serial Bus (USB) the PCI Express bus. Southbridge 935 includes USB Controller 940 that provides USB connectivity to devices that connect to the USB. These devices include webcam (camera) 950, infrared (IR) receiver 948, keyboard and trackpad 944, and Bluetooth device 946, which provides for wireless personal area networks (PANs). USB Controller 940 also provides USB connectivity to other miscellaneous USB connected devices 942, such as a mouse, removable nonvolatile storage device 945, modems, network cards, ISDN connectors, fax, printers, USB hubs, and many other types of USB connected devices. While removable nonvolatile storage device 945 is shown as a USB-connected device, removable nonvolatile storage device 945 could be connected using a different interface, such as a Firewire interface, etcetera.

Wireless Local Area Network (LAN) device 975 connects to Southbridge 935 via the PCI or PCI Express bus 972. LAN device 975 typically implements one of the IEEE 802.11 standards of over-the-air modulation techniques that all use the same protocol to wireless communicate between information handling system 900 and another computer system or device. Optical storage device 990 connects to Southbridge 935 using Serial ATA (SATA) bus 988. Serial ATA adapters and devices communicate over a high-speed serial link. The Serial ATA bus also connects Southbridge 935 to other forms of storage devices, such as hard disk drives. Audio circuitry 960, such as a sound card, connects to Southbridge 935 via bus 958. Audio circuitry 960 also provides functionality such as audio line-in and optical digital audio in port 962, optical digital output and headphone jack 964, internal speakers 966, and internal microphone 968. Ethernet controller 970 connects to Southbridge 935 using a bus, such as the PCI or PCI Express bus. Ethernet controller 970 connects information handling system 900 to a computer network, such as a Local Area Network (LAN), the Internet, and other public and private computer networks.

While FIG. 9 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

FIG. 10 provides an extension of the information handling system environment shown in FIG. 9 to illustrate that the methods described herein can be performed on a wide variety of information handling systems that operate in a networked environment. Types of information handling systems range from small handheld devices, such as handheld computer/mobile telephone 1010 to large mainframe systems, such as mainframe computer 1070. Examples of handheld computer 1010 include personal digital assistants (PDAs), personal entertainment devices, such as MP3 players, portable televisions, and compact disc players. Other examples of information handling systems include pen, or tablet, computer 1020, laptop, or notebook, computer 1030, workstation 1040, personal computer system 1050, and server 1060. Other types of information handling systems that are not individually shown in FIG. 10 are represented by information handling system 1080. As shown, the various information handling systems can be networked together using computer network 1000. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 10 depicts separate nonvolatile data stores (server 1060 utilizes nonvolatile data store 1065, mainframe computer 1070 utilizes nonvolatile data store 1075, and information handling system 1080 utilizes nonvolatile data store 1085). The nonvolatile data store can be a component that is external to the various information handling systems or can be internal to one of the information handling systems. In addition, removable nonvolatile storage device 945 can be shared among two or more information handling systems using various techniques, such as connecting the removable nonvolatile storage device 945 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A computer-implemented method comprising:
generating, by a source entity, scene fill metadata corresponding to one or more scene transition points included in a media content, wherein the scene fill metadata includes a required buffer amount of the media content to buffer prior to displaying one or more corresponding scenes included in the media content; and
providing the scene fill metadata to a destination entity.

2. The method of claim 1 wherein a first one of the corresponding scenes is embedded between a first scene transition point and a second scene transition point included in the one or more scene transition points, the method further comprising:
including a scene transition frame identifier corresponding to the first scene transition point in the scene fill metadata;
identifying a size of the first scene; and
determining the required buffer amount based upon the size of the first scene.

3. The method of claim 2 wherein the source entity is a content distributor and the destination entity is a content receiver, the method further comprising:
creating, by the content distributor, composite media content that includes the scene fill metadata and the media content; and
streaming, by the content distributor, the composite media content to the content receiver.

4. The method of claim 3 further comprising:
detecting, at the content receiver, the scene fill metadata;
buffering, by the content receiver, the first corresponding scene to the required buffer amount; and
displaying, by the content receiver, the first corresponding scene subsequent to buffering the first corresponding scene to the required buffer amount.

5. The method of claim 4 further comprising:
inhibiting, by the content receiver, the displaying of the first corresponding scene until after the first corresponding scene is buffered to the required buffer amount; and
extending the displaying of a scene transition frame during the inhibition of displaying the first corresponding scene.

6. The method of claim 4 further comprising:
inhibiting, by the content receiver, the displaying of the first corresponding scene until after the first corresponding scene is buffered to the required buffer amount;
displaying a commercial during the inhibition of displaying the first corresponding scene; and
sending a message to a content distributor that indicates the displaying of the commercial.

7. The method of claim 3 wherein the scene fill metadata is inserted between the one or more corresponding scenes in the composite media content.

8. The method of claim 3 wherein the scene fill metadata is included in the composite media stream at a location prior to a location of the mediate content.

9. The method of claim 1 wherein the required buffer amount is selected from the group consisting of a number of frames, a time duration, and a data size.

10. A computer-implemented method comprising:
detecting, at a content receiver, scene fill metadata corresponding to one or more scene transition points included in a media content, wherein the scene fill metadata includes a required buffer amount of the media content to buffer prior to displaying one or more corresponding scenes included in the media content;
buffering, by the content receiver, a first one of the corresponding scenes to the required buffer amount; and
displaying, by the content receiver, the first corresponding scene subsequent to buffering the first corresponding scene to the required buffer amount.

11. The method of claim 10 further comprising:
inhibiting, by the content receiver, the displaying of the first corresponding scene until after the first corresponding scene is buffered to the required buffer amount;
displaying a commercial during the inhibition of displaying the first corresponding scene; and
sending a message to a content distributor that indicates the displaying of the commercial.
